(19) United States
(12) Patent Application Publication
(10) Pub. No.: US 2026/0143213 A1
(43) Pub. Date: May 21, 2026

(54) CAMERA AND MOUNTING METHOD

(71) Applicant: MEKRA Lang GmbH & Co. KG, Ergersheim (DE)

(72) Inventors: Susanne LANG, Ergersheim (DE); Christian TRAUB, Ansbach (DE)

(21) Appl. No.: 19/386,659

(22) Filed: Nov. 12, 2025

(30) Foreign Application Priority Data
Nov. 15, 2024 (DE) 10 2024 133 497.5

(51) Int. Cl. H04N 23/51; B60R 16/03; H04N 23/52; H04N 23/54; H04N 23/55

(52) U.S. Cl. CPC H04N 23/51; B60R 16/03; H04N 23/52; H04N 23/54; H04N 23/55

(57) ABSTRACT

A camera for a vehicle is provided, comprising a housing which forms a housing cavity, an image sensor board arranged in the housing cavity, which divides the housing cavity into a first housing section and a second housing section, an image sensor mounted on a first side of the image sensor board, and a module firmly fixed to the housing and/or the image sensor board, which has an optical system, an electronic component and an electrical connecting line connected to the electronic component, the connecting line being guided in the housing cavity through the image sensor board or along the image sensor board, and the connecting line being contacted on a second side of the image sensor board or by a housing cover or contacting board arranged in the second housing section.

### TECHNICAL FIELD

The present disclosure relates to a camera for a vehicle, in particular a commercial vehicle, comprising a housing that forms a housing cavity, an image sensor board arranged in the housing cavity, which divides the housing cavity into a first housing section and a second housing section, an image sensor mounted on a first side of the image sensor board, and a module firmly attached to the housing and/or the image sensor board, which has an optical system, an electronic component, and an electrical connecting line connected to the electronic component.

### BACKGROUND OF THE DISCLOSURE

Such a camera is already known from EP 2 884 736A 1. In particular, it discloses a camera for use on vehicles, especially commercial vehicles, that comprises a housing, at least one optical element arranged in or on the housing, a circuit board group arranged in the housing and comprising at least one circuit board, each with at least one active circuit for performing a direct camera function, at least one heating element arranged and adapted for heating the circuit board group, the optical element and/or the housing, the at least one heating element being attached directly to one of the circuit boards of the circuit board group, and at least one heat-conducting element arranged between the at least one heating element and the housing and adapted for transferring the heat of the heating element and/or the circuit board group into the housing. The heating element is arranged directly on the circuit board so that the optical element can be heated through a thermal contact connection on the circuit board. However, such a structure is only suitable for smaller optical elements, as the heating power may not be sufficient for larger optical elements.

Furthermore, such a camera is already known from EP 3 035 665A 1. In particular, the document discloses a camera system for a vehicle, comprising a lens; a first printed circuit board provided with an image sensor for capturing image information obtained via the lens; and at least one further printed circuit board providing a predetermined basic function for the camera system, the first printed circuit board and each of the at least one further printed circuit boards comprising at least one connection unit via which the printed circuit boards can be connected to each other in a modularly exchangeable manner for adapting the functional scope of the camera system in accordance with the predetermined basic function, the at least one connection unit including a plurality of groups of electric connections via which the first printed circuit board can be connected to the at least one further printed circuit board so as to provide the predetermined basic function for the camera system.

Moreover, U.S. Pat. No. 11,086,092 B2 discloses a lens assembly for a camera module, which comprises a lens and a heating assembly arranged on the lens, the heating assembly being configured to generate heat when an electric current flows through it. The heating assembly is contacted via an image sensor board by a wire connecting the heating assembly to a side of the image sensor board facing the lens.

In such cameras, it is crucial that the optics are precisely positioned resp. aligned with the image sensor in order to ensure focusing and thus sharp image capture. The optics is positioned resp. fixed to the image sensor via an adhesive bond. However, the prior art always has the disadvantage that, during mounting of the camera, forces can act on the adhesive bond due to the structural arrangement of the individual camera components, which may have a decisive effect on the positioning of the optics relative to the image sensor, especially if the adhesive bond has not yet sufficiently hardened. In particular, any tension on the image sensor board may cause the optimal focus point to be lost.

In particular, when the connecting line connected to the electronic component is fixed to the image sensor board, traction or pressure on the connecting line may lead to a slight movement of the optics relative to the image sensor board and thus to the image sensor, which in turn can lead to loss of the focus point.

### SUMMARY OF THE PRESENT DISCLOSURE

The task of the present disclosure is therefore to avoid or at least reduce the disadvantages of the prior art. In particular, a camera is to be provided in which precise alignment of the optics with the image sensor can be safeguarded, which in particular is not influenced negatively by the contact of the connecting line.

The task of the present disclosure is solved by a camera including the features of claim 1, resp. by a mounting method having the features of the independent claim.

Accordingly, the task of the present disclosure is solved by a camera. The camera is intended for use in a vehicle, in particular a commercial vehicle. For example, the camera can be a component of a camera monitor system, such as a mirror replacement system.

The camera has a housing that forms a housing cavity. This means that components of the camera can be arranged inside the housing or at least partially enclosed by the housing.

The camera has an image sensor board located in the housing cavity. The image sensor board can also be referred to as a sensor head board. The image sensor board divides the housing or housing cavity into a first housing section and a second housing section. This means that the image sensor board or a cross-sectional plane of the image sensor board separates the housing cavity into two housing sections. In this context, “divide” or “separate” does not mean a sealed or closed boundary, but rather that the housing sections can be connected to each other, for example, by a free space. The first housing section also can be referred to as front housing section while the second housing section can be referred to as rear housing section.

The camera has an image sensor attached to a first side of the image sensor board. The first side of the image sensor board also can be referred to as front side, while a second side of the image sensor board, which is opposite to the first side, also can be referred to as rear side. The first side of the image sensor board is arranged in the first housing section or faces the first housing section, and the second side of the image sensor board is arranged in the second housing section or faces the second housing section. This means that the image sensor is arranged in the first housing section or faces the first housing section.

The camera has a module that is permanently attached to the housing and/or the image sensor board. This means that the module has a fixed resp. defined position in relation to the housing and/or the image sensor board. The module comprises an optical system, an electronic component, and an electrical connecting line connected to the electronic component. In particular, the components of the module may be firmly connected to each other. The optics also can be referred to as lens or lens arrangement. The connecting line serves in particular to supply the electronic component with power/voltage and/or data. The data may include, for example, data/signals for control purposes. The optics may be arranged in particular on resp. in the first housing section. This means that the first side of the image sensor board can face the optics. Accordingly, the first side of the image sensor board can be referred to as optics side. Furthermore, an arrangement in the first housing section resp. in an area beyond/on the first side of the image sensor board also can be referred to as being on the optics side. The electronic component can be arranged in particular in the area of the optics resp. in the first housing section or on the optics side. This means that the first side of the image sensor board can face the electronic component.

According to one aspect of the present disclosure, the connecting line passes through the image sensor board or along the image sensor board in the housing cavity. In other words, the connecting line extends along the image sensor board from the first housing section into the second housing section. Passing through the image sensor board or along the image sensor board means, in particular, that the connecting line is not integrated in the image sensor board, but is independent of the image sensor board and is not a component of the image sensor board. In particular, this means that the connecting line passes through and/or alongside the image sensor board in a force-free manner (as far as possible) resp. alongside the image sensor board without making electrical contact with it. This means that a first end or contacting element of the connecting line is located beyond the first side of the image sensor board (i.e., on the optics side resp. in front of the image sensor board or on/at the front side of the image sensor board) and a second end or contact element of the connecting line is located beyond the second side of the image sensor board (i.e., behind the image sensor board or on/at the rear side of the image sensor board). The (first or second) contacting element can be designed in particular as a plug and/or a contact spring and/or a spring contact. The first contacting element serves to make (direct) contact with the electronic component. The first contacting element can also be integrally transitioned into the electronic component, for example as a (sheathed) wire that transitions into a heater, for example a heating foil of the heater. The first contacting element serves to contact plural electronic components or form several contacts via the (multi-part) electronic component. In particular, the connecting line passing through is not to be understood as meaning that a first line is connected, for example, to the front side of the image sensor board, that lines are formed within the image sensor board (between individual layers of the image sensor board), and that the rear side of the image sensor board is connected to a second line, which in turn serves for contacting in the second housing section. However, this also means that the connecting line is not limited to being constructed in one piece between the first contacting element and the second contacting element.

According to the aspect of the present disclosure, the connecting line is contacted on a second side of the image sensor board or by a housing cover or contacting board arranged in the second housing section. This means that the second contacting element serves to (directly/immediately) contact the second side of the image sensor board (i.e., on the rear side of the image sensor board) or the housing cover (facing the rear side of the image sensor board) or the contacting board (facing the rear side of the image sensor board). In other words, a connection point for the second contacting element is arranged in the second housing section and is formed, for example, by the rear side of the image sensor board itself, a housing component, in particular the housing cover, or the contacting board. In particular, the second contacting element serves as a voltage connection and/or as a data connection for the electronic component. In other words, the electronic component is supplied with voltage and/or data via the image sensor board, the housing cover, or the contacting board.

The core of the disclosure consequently is that the electronic component, which is located in the optics area and thus in a front area of the housing or camera, can be contacted via the connecting line in a rear area of the housing or camera, the connecting line being routed through the image sensor board (which separates the front area from the rear area) (physically/in terms of installation space/mechanically or without electrical contact with the image sensor board) resp. along the image sensor board. In other words, the camera has a connection point for supplying power and/or data to the electronic component in another area of the housing, the connection between the electronic component and the connection point being made via the connecting line that passes through the image sensor board or between the image sensor board and an inner wall of the housing.

This has the advantage that the connecting line in particular no longer contacts the front of the image sensor board. Contacting on the front of the image sensor board would have to be made during the assembly process to align the optics with the image sensor, as the front of the image sensor board is no longer accessible afterwards. However, when making contact or moving the camera (even after assembly), forces would be applied to the connecting line, which could affect the alignment of the optics with the image sensor and lead to a loss of the focus point. By passing the connecting line through the image sensor board resp. passing it along the image sensor board, it is possible to contact the connecting line from the rear of the housing and only after the assembly process for aligning the optics with the image sensor. Thus, after the adhesive bond has hardened, contacting can be established by connecting the connecting line to the rear of the image sensor board, the housing cover, or a connection board. Accordingly, the alignment of the optics with the image sensor can be improved or ensured.

According to one embodiment, the connecting line may be flexible, for example in the form of a cable or wire or a flexprint connection, or it may be rigid.

According to one embodiment, a component forming the connection point, i.e., the image sensor board, the housing cover, or the contacting board, may have a connection, in particular a plug connection, which serves for connecting, in particular plug connecting, to another component. This means that the component forming the connection point does not itself have to ensure the supply of voltage and/or data, but rather the supply is only provided via the component forming the connection point, but downstream contacting can take place.

According to a preferred embodiment, a recess may be formed within the image sensor board or between an inner wall of the housing and the image sensor board, through which the connecting line extends. Moreover, also additional components, such as a cable guide connected to the housing, may also be arranged between the inner wall of the housing and the image sensor board or in the recess formed thereby. The recess may be formed for example, by a (through) hole in the direction of the board thickness. Alternatively, the recess can be formed by matching the cross-sections of the image sensor board and the housing in the area of the image sensor board, in particular by making the cross-section of the image sensor board smaller than the housing cross-section or less filled, resulting in the recess between the inner wall of the housing and the image sensor board. This means that the recess can be formed within the image sensor board and can be completely surrounded/enclosed by image sensor board material on its circumferential side. This also means that the recess between the inner wall of the housing and the image sensor board can be formed and surrounded/enclosed on the circumference partially by the inner wall of the housing and partially by the image sensor board. In other words, the image sensor board may have a smaller cross-section than the housing (in the area of the image sensor board). This means that the recess allows the connecting line to extend/pass through (perpendicular to the cross-section of the image sensor board) the image sensor board or along it.

According to a further development of the preferred embodiment, the recess may have a larger cross-section than the connecting line. In particular, the connecting line may be arranged or can be arranged so that it is largely or completely spaced apart from the housing and/or the image sensor board on the circumferential side. This has the advantage that the connecting line can be guided in a force-free manner if possible.

According to a preferred embodiment, the optics may be bonded to the housing and/or the image sensor board, in particular in the area of the first side of the image sensor board. In other words, the lens assembly is connected to the housing and/or the image sensor board via at least one bonding point/adhesive area. This ensures precise positioning of the optics relative to the image sensor. Preferably, the bonding point (or a first bonding point) can be arranged on the first side of the image sensor board and circumferentially surround the image sensor. For example, the bonding point can be designed in a (closed) circular ring shape. This allows the alignment to be reliably fixed. Preferably, the bonding point (or a second bonding point) can be arranged on one end face of the housing. For example, the bonding point can be designed in a (closed) circular ring shape.,

In particular, the optics is positioned or aligned with respect to a distance and/or an inclination to the image sensor in order to ensure focused imaging. The optics may be centered or aligned with an axis offset to the image sensor.

According to a preferred embodiment, the image sensor board can be firmly connected to the housing, in particular by being caulked, for example, via pins on the housing and holes on the image sensor board, and/or screwed and/or glued. This ensures a fixed positioning between the image sensor board and the housing. Such precise positioning is particularly important if the optics is also glued to the image sensor board. Alternatively, the image sensor board also need not be firmly connected to the housing, but the optics is firmly connected to the housing. In this case, the image sensor board can be aligned with the optics. This means that the image sensor board is only indirectly connected to the housing via the optics.

According to a preferred embodiment, the housing may have a (cable) guide for the connecting cable. The guide may, for example, be in the form of clips or in the form of a frame.

According to a preferred embodiment, the electronic component may be a heater and/or a focusing device and/or a cleaning element and/or a control element for controlling an electric motor and/or a light source. The heater may, for example, be constructed like a heating arrangement described in U.S. Pat. No. 11,086,092 B2 and connected to the image sensor board. The focusing device may serve to focus and/or change a filter or an aperture. The light source may be an infrared light source in particular. The electronic component may be arranged in particular in the area of the optics. The electronic component is preferably, but not necessarily, connected to the optics. In particular, the electronic component serves to provide additional functions for the optics. This means that the electronic component can be functionally associated with the optics and/or can be arranged in close proximity to the optics, resp. is not a completely arbitrary electronic component.

According to a preferred embodiment, the connecting line may be connected directly to a connection point formed on a second side of the image sensor board or on the housing cover or on the contacting board, the connection between the connecting line and the connection point being formed as a floating connection. In other words, when the connecting line is contacted, there is a flexible connection, for example by means of springs, so that only a reduced force is exerted on the overall system. This means that there may be some play between the connecting line resp. the (second) contacting element and the connection point. This has the advantage that any force generated by the connection between the (second) contacting element and the connection point, which could act on the alignment of the optics with the image sensor, is reduced.

According to a preferred embodiment, the camera may have a voltage source or a voltage connection for connecting to an external voltage source. According to the preferred embodiment, the voltage source or voltage connection may be located in the housing cavity and connected to the electronic component via the connecting line. This means that the component forming the connection point may directly contain the voltage source and may serve to directly supply voltage to the electronic component, or else the component forming the connection point itself may serve as a direct connection to a voltage source and to indirectly supply voltage to the electronic component. In other words, the voltage source can be installed in the camera or an external voltage source can be used to supply voltage, whereby the external voltage source is connectable or can be connected via, for example, a power-over-coax or a power-over-dataline or a separate connecting line.

According to a preferred embodiment, the connecting line, if it serves to supply the electronic component with data, is connectable or may be connected to a microcontroller or a control element of a vehicle communication network, such as a CAN bus (Controller Area Network Bus) or the like.

According to a preferred embodiment, the housing cover may be partially made of plastic. According to the preferred embodiment, the housing cover may have a (metallic) contacting element. The contacting element of the housing cover may serve in particular as a connection point, i.e., for contacting the second contacting element of the connecting line. The contacting element may preferably be overmolded, in particular be formed as an insert component. This allows free design of the housing cover while maintaining electrical contactability.

Accordingly, the task of the present disclosure also is solved by a mounting method for a camera, in particular the camera described above. The mounting method comprises the following steps:
connecting the module to the housing and/or the image sensor board via an adhesive bond in such a way that the optics is aligned to the image sensor or the image sensor is aligned to the optics,
curing the adhesive bond,
contacting the connecting line, connecting being made after the adhesive bond has cured.

In other words, the optics is aligned to the image sensor (or the image sensor to the optics) via at least one adhesive joint on the housing and/or the image sensor board (to ensure focusing), the connecting line being connected to the connection point after the adhesive of the adhesive joint(s) has cured.

According to a preferred embodiment, no external force may be applied to the adhesive joint before the adhesive has cured. This means that only the dead weight and an adjustment aid during the assembly process may exert a force.

According to a preferred embodiment, the connecting line may be contacted within the second housing section.

According to a preferred embodiment, the adhesive bond can be fixed by UV light before curing. This allows (light) fixation to be achieved before curing.

According to a preferred embodiment, the adhesive bond can be fully cured in a temperature range of 25 to 200° C., in particular 60 to 100° C., preferably 80 to 90° C., and more preferably 85° C. This means that curing takes place at elevated temperatures. This allows the strength to be increased.

### BRIEF DESCRIPTION OF THE DRAWINGS

FIGS. 1 to 5 show different perspective views of a camera according to the disclosure resp. its individual parts,

FIGS. 6 and 7 show the camera at different stages of its assembly,

FIG. 8 shows a side view of the camera, and

FIG. 9 shows a longitudinal section, cut along line IX from FIG. 8, of the camera according to the disclosure.

### DETAILED DESCRIPTION

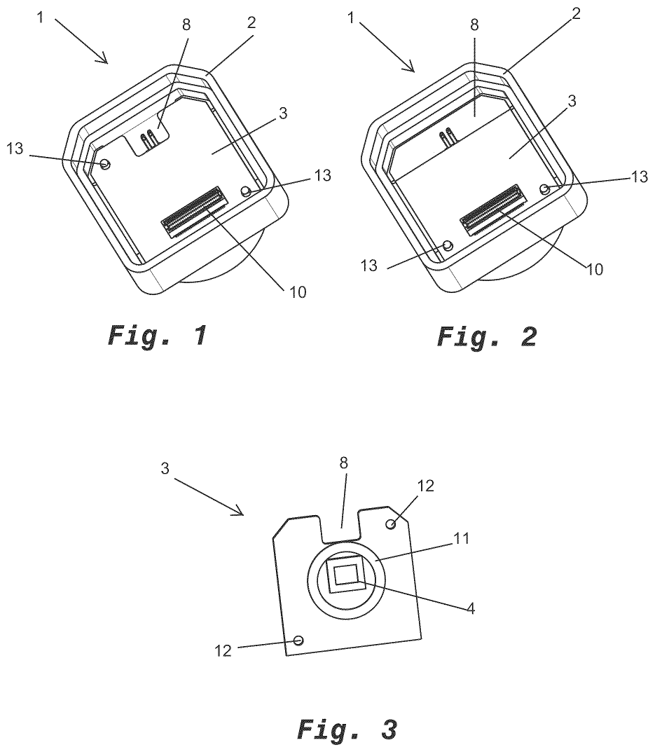

FIGS. 1 to 5 show perspective views of a camera 1 according to the present disclosure and its components. Camera 1 is intended for use with a vehicle, in particular a commercial vehicle. For example, camera 1 may be a component of a camera monitor system, such as a mirror replacement system.

The camera 1 has a housing 2. Housing 2 forms resp. defines a housing cavity. A first side of housing 2 can be referred to as a front side of the housing, while a second side of housing 2, opposite the first side, can be referred to as a rear side of the housing.

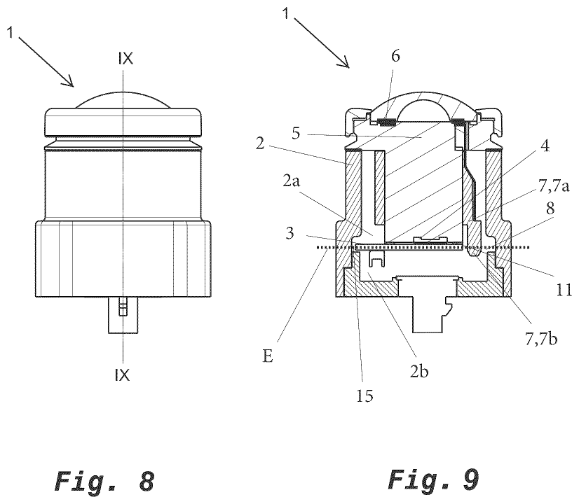

The camera 1 has an image sensor board 3 arranged in the housing cavity. The image sensor board 3 is enclosed on the circumferential side by the housing 2. The image sensor board 3 on its edge can be in direct contact with the housing 2 at least in sections or spaced apart from the housing 2 by a circumferential gap 15 (see FIG. 9). The image sensor board 3 can in particular be firmly connected to the housing 2, in particular caulked to the housing 2.

The image sensor board 3 divides the housing 2 resp. the housing cavity into a first housing section 2a and a second housing section 2b. The first housing section 2a is located on a first side of the image sensor board 3. The second housing section 2b is located on a second side (facing the first side/opposite to the first side) of the image sensor board 3. The first housing section 2a can also be referred to as a front housing section. The first side of the image sensor board 3 can also be referred to as a front side. The second housing section 2b can also be referred to as a rear housing section. The second side of the image sensor board 3 can also be referred to as a rear side. FIGS. 1 and 2 show a view of the rear side of the housing and the rear side of the image sensor board 3.

In the embodiment shown, the front housing section 2a has a front opening. This means that the housing 2 is accessible from the front of the housing in order to insert components in the housing 2. In the embodiment shown, the rear housing section has a rear opening. This means that the housing 2 is accessible from the rear of the housing in order to insert components in the housing 2. At least one of the two openings, in the embodiment shown the rear opening, is larger than the image sensor board 3 in order to be able to insert the image sensor board 3 in the housing 2.

The camera 1 has an image sensor 4. The image sensor 4 is firmly fixed to the front of the image sensor board 3. FIG. 3 shows a view onto the front of the image sensor board 3.

The camera 1 has an optical system 5. The optical system 5 is firmly fixed to the housing 2 and/or the image sensor board 3. In particular, the optical system 5 may be glued to the housing 2 and/or the image sensor board 3. The optical system 5 is arranged in resp. on the front housing section 2a. In particular, the optical system 5 may close the front opening of the housing 2 resp. the front housing section 2a. The optical system 5 may be arranged partly inside and partly outside the housing cavity. In particular, the front side of the image sensor board 3 may face the optical system 5, or the optical system 5 may be arranged on resp. in the area of the front side of the housing. FIG. 4 shows a view in which the optical system 5 is already connected to the image sensor board 3.

The camera 1 has an electronic component 6. The electronic component 6 is located in the area of the optical system 5 or in the area of the front side of the housing. The optical system 5 may, for example, form a cavity within which the electronic component 6 is accommodated. In the embodiment shown, the electronic component 6 is designed as a heater for the optical system 5. Alternatively, the electronic component 6 can be designed as a focusing device. Alternatively, the electronic component 6 can be designed as a cleaning element. Alternatively, the electronic component 6 can be designed as a control element for controlling an electric motor and/or a light source. The camera 1 may also have plural electronic components 6. The plural electronic components 6 may have different functions, in particular the aforementioned functions.

The camera 1 has an electrical connecting line 7. The connecting line 7 is connected to the electronic component 6. In particular, the connecting line 7 (at a first end) may have a first contacting element for contacting the electronic component 6. In addition, the connecting line 7 (at a second end) may have a second contacting element for contacting a connection point of the camera 1 for power supply and/or data supply.

According to the present disclosure, the connecting line 7 in the housing cavity is guided through the image sensor board 3 or along the image sensor board 3. The connecting line 7 (resp. the second contacting element) is contacted on/from the rear side of the image sensor board 3 (not shown) or by a housing cover (not shown) arranged in the second housing section 2b or by a contacting board 9 arranged in the second housing section 2b (see FIG. 5). This means that the electronic component 6 and the connection point for the connecting line 7 are arranged in different housing sections, namely the electronic component 6 in the first housing section 2a and the connection point in the second housing section 2b.

For this purpose, the camera 1 has a recess 8 which is formed within the image sensor board 3 (not shown) or between an inner wall of the housing and the image sensor board 3 (see FIGS. 1 and 2). The connecting line 7 extends through the recess 8. The recess 8 may, for example, be formed by a cutout that extends inwardly opposite an edge of the image sensor board 3 (see FIG. 1). The recess 8 may also be formed, for example, by adjusting or reducing a cross-section of the image sensor board 3 so that there is a free space resp. unfilled cross-section between an edge of the image sensor board 3 and the inner wall of the housing.

Moreover, FIG. 2 shows that a plug connection 10, in particular in the form of a plug connector, such as a stack plug connection, can be formed on the rear side of the image sensor board 3 in order to electronically connect the image sensor board 3 to another board, for example the contacting board 9, or another component.

Furthermore, FIG. 3 shows that an adhesive area 11, in particular in the form of a (circular) glue bead, can be applied to the front side of the image sensor board 3 in order to attach the optical system 5 thereto. The adhesive area 11 is placed around the image sensor 4.

Furthermore, from FIGS. 1 to 5 it is to be discerned that the image sensor board 3 has holes 12 and the housing 2 has pins 13, via which the image sensor board 3 can be caulked to the housing 2.

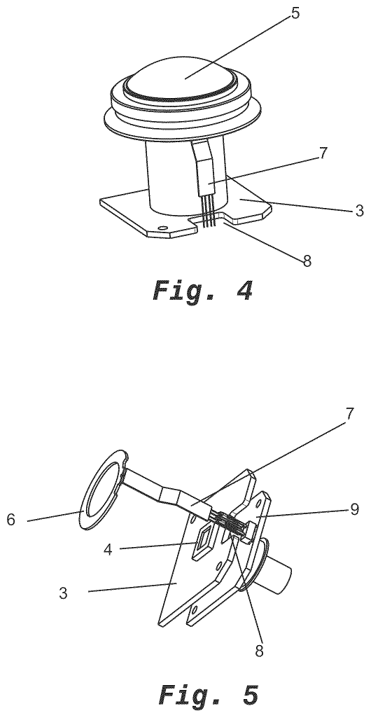

FIGS. 6 and 7 show the camera at different stages of assembly. FIG. 6 shows that the image sensor board 3 is inserted into the housing 2 from the rear of the housing. The adhesive area 11 is formed on the front side of the image sensor board 3. An adhesive area 14, in particular in the form of a (circular) glue bead, also is formed on an end face of the housing 2 resp. a housing component in order to fix the optical system 5 thereto.

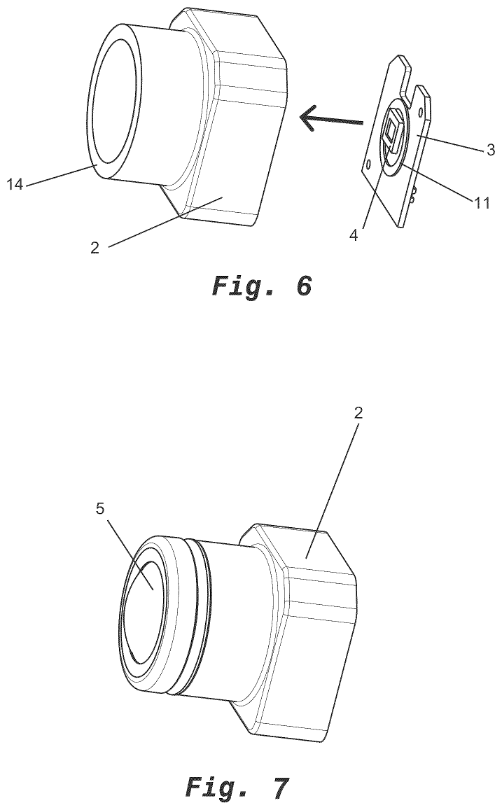

FIG. 8 shows a side view of the camera. FIG. 9 shows a longitudinal section of camera 1 along line IX in FIG. 8. This view shows particularly well that the image sensor board 3 defines a plane E that divides the housing 2 resp. the housing cavity into two sections, namely the first housing section 2a and the second housing section 2b. The image sensor 4, the optical system 5, the electronic component 6, and a front section 7a of the connecting line 7 are arranged in the first housing section 2a, while a rear section 7b of the connecting line 7 is arranged in the second housing section 2b, the connecting line 7 extending through the recess 8 arranged in the plane, namely through the image sensor board 3 or along the image sensor board 3.

FIG. 9 also shows that the circumferential gap 15 can be formed between the inner wall of the housing and the image sensor board, but that this gap is smaller than the cross-section of the connecting line 7.

Moreover, in FIG. 9 the adhesive area 11 is to be recognized through which the image sensor board 3 and the optical system 5 are connected to each other.

### LIST OF REFERENCE SIGNS

1 Camera
2 Housing
2a First housing section
2b Second housing section
3 Image sensor board
4 Image sensor
5 Optical system
6 Electronic component
7 Connecting line
7a Front section
7b Rear section
8 Recess
9 Contacting board
10 Plug connection
11 Adhesive area
12 Hole
13 Pin
14 Adhesive area
15 Circumferential gap
E Plane

1. A camera for a vehicle, comprising:
a housing that forms a housing cavity,
an image sensor board arranged in the housing cavity, which divides the housing cavity into a first housing section and a second housing section,
an image sensor mounted on a first side of the image sensor board, and
a module firmly fixed to the housing and/or the image sensor board, which comprises an optical system, an electronic component, and an electrical connecting line connected to the electronic component,
wherein the connecting line in the housing cavity is guided through the image sensor board or along the image sensor board, and the connecting line is contacted on a second side of the image sensor board or by a housing cover or contacting board arranged in the second housing section.

2. The camera according to claim 1, wherein a recess is formed within the image sensor board or between an inner wall of the housing and the image sensor board through which the connecting line extends.

3. The camera according to claim 1, wherein the optical system is glued to the housing.

4. The camera according to claim 1, wherein the optical system is glued to the image sensor board in the area of the first side of the image sensor board.

5. The camera according to claim 1, wherein the image sensor board is firmly connected to the housing.

6. The camera according to claim 5, wherein the image sensor board is caulked and/or screwed and/or glued to the housing.

7. The camera according to claim 5, wherein the image sensor board is connected to the housing via the optical system.

8. The camera according to claim 1, wherein the electronic component is a heater.

9. The camera according to claim 1, wherein the electronic component is a focusing device.

10. The camera according to claim 1, wherein the electronic component is a cleaning element.

11. The camera according to claim 1, wherein the electronic component is a control element for controlling an electric motor.

12. The camera according to claim 1, wherein the electronic component is a light source.

13. The camera according to claim 1, wherein the connecting line is directly connected to a connection point formed on a second side of the image sensor board or on the housing cover or on the contacting board, the connection between the connecting line and the connection point being formed as a floating connection.

14. The camera according to claim 1, wherein the camera has a voltage source or a voltage connection for connection to an external voltage source, the voltage source or voltage connection being arranged in the housing cavity and being connected to the electronic component via the connecting line.

15. A mounting method for a camera according to claim 1, comprising the following steps:
connecting the module to the housing and/or the image sensor board via an adhesive joint such that the optical system is aligned with the image sensor or the image sensor is aligned with the optics,
curing the adhesive joint,
contacting the connecting line, the contacting taking place after the adhesive joint has cured.

16. The mounting method according to claim 15, wherein the contacting of the connecting line takes place within the second housing section.

17. The mounting method according to claim 15, wherein the adhesive joint is fixed by UV light before curing.
